(19) United States
(12) Patent Application Publication
(10) Pub. No.: US 2013/0233799 A1
(43) Pub. Date: Sep. 12, 2013

(54) FILTRATION MODULE

(71) Applicant: TECHNION RESEARCH & DEVELOPMENT FOUNDATION LTD., (US)

(72) Inventors: Carlos Dosoretz, Carmiel (IL); Avner Ronen, Zichron Yaakov (IL); Raphael Semiat, Haifa (IL)

(73) Assignee: TECHNION RESEARCH & DEVELOPMENT FOUNDATION LTD., Haifa (IL)

(21) Appl. No.: 13/771,219

(22) Filed: Feb. 20, 2013

Related U.S. Application Data
(60) Provisional application No. 61/601,102, filed on Feb. 21, 2012.

(51) Int. Cl. B01D 69/02

(52) U.S. Cl. CPC B01D 69/02
USPC 210/650; 210/500.21

(57) ABSTRACT

The present invention provides a filtration module having at least one membrane layer and a spacer layer, wherein the spacer includes: a polymeric matrix; and a biocide physically embedded into or attached to the polymeric matrix. Moreover, the invention provides a method for reducing the concentration of bacteria in water, by contacting water with the filtration module.

### FIELD OF INVENTION

This invention is directed to; inter alia, a filtration module having a biocide modified spacer directly contacting a membrane.

### BACKGROUND OF THE INVENTION

Antimicrobial modification of surfaces to prevent growth of detrimental microorganisms is a highly desired objective. Microbial infestation of surfaces is one of the leading causes of infections. This often leads to life threatening complications.

Water purification is the process of removing undesirable chemicals, biological contaminants such as bacteria, suspended solids and gases from contaminated water. The goal is to produce water fit for a specific purpose. Most water is purified for human consumption (drinking water). In general the methods used include physical processes such as filtration, sedimentation, and distillation, biological processes such as slow sand filters or biologically active carbon, chemical processes such as flocculation and chlorination and the use of electromagnetic radiation such as ultraviolet light.

Pressure driven-membrane separation processes are a key technology for water purification and production of new water sources. Membranes are susceptible to fouling. Biofouling is the most complex and difficult to solve form of fouling and hinders the utilization of membrane technology in many applications. Biofouling is defined operationally and refers to that amount of biofilm development which interferes with technical or economic requirements.

A biofilm is a microbial aggregate which occurs at the interface of any flowing system. Microorganisms are present in nearly all water treatment systems. They tend to adhere to surfaces and grow, mainly by using nutrients extracted from the water phase. A feature that all biofilms have in common is that the organisms are embedded in a matrix of microbial origin, consisting of extracellular polymeric substances (EPS). Once they form, biofilms can be very difficult to remove. The EPS impart the characteristic properties of biofilms, and among them the remarkable resistance to biocides that would otherwise kill it in the planktonic state (Flemming, 1997; Baker &Dudley, 1998

In pressure driven-membrane separation systems, bacterial transport toward the membrane by permeate drag has been found to be a mechanism by which cross-flow filtration contributes to the buildup of a biofouling layer that was more dominant than transport of nutrients (Eshed et al., 2008). Development of biofouling on separation membranes results in a dramatic decrease of productivity, especially when nutrients are present in the feedwater, as is the case with wastewater effluents. Once biofouling is initiated, the most dramatic effect on membrane permeability decline might is probably due to the formation and accumulation of EPS (Ivnitsky et al., 2005; 2007).

Membrane filtration processes are classified according to the membrane pore sizes, which dictate the size of the particles they are able to retain (see table). The membranes are made from materials such as thin organic polymer films, metals or ceramics, depending on the application. They are manufactured in different forms such as hollow fibres or flat sheets, which are incorporated into housing modules designed to produce optimal hydrodynamic conditions for separation.

Complete systems comprise arrangements of modules, together with the interfaces and control systems needed to integrate them into the various process configurations. Multi-stage treatment purification typically begins with a pre-treatment stage to remove contaminants that would otherwise affect the downstream equipment. Methods such as activated carbon filtration may be used for chlorine removal, cartridge or deep-bed filters for particle removal, and softening agents to remove minerals that cause hardness in the water.

### SUMMARY OF THE INVENTION

In one embodiment, the present invention provides a filtration module comprising at least one membrane layer and a spacer layer, wherein the spacer comprises (i) a polymeric matrix; and (ii) biocide, wherein the biocide is physically embedded into or attached to the polymeric matrix. In another embodiment, a filtration module comprises a tubular shape. In another embodiment, a filtration module further comprises water.

In another embodiment, the present invention further provides a filtration module having a tubular shape, and comprising two permeable or a semi-permeable membrane layers and a spacer layer a sandwiched between the two membrane layers, wherein the outer circumference of the module consists a membrane layer.

In another embodiment, the present invention further provides a filtration module having a tubular shape, and comprising a coiled bilayer, wherein the bilayer comprises a single permeable or semi-permeable membrane layer directly contacting a single spacer layer, wherein the outer circumference of the module consists the single membrane layer.

In another embodiment, the present invention further provides a method for reducing bacteria concentration in water, comprising the step of contacting water with a filtration module comprising at least one membrane layer and a spacer layer, wherein the spacer comprises (i) a polymeric matrix; and (ii) biocide, wherein the biocide is physically embedded into or attached to the polymeric matrix.

### BRIEF DESCRIPTION OF THE DRAWINGS

FIG. 1. Is a scheme of a membrane separation module (Membrane Technology and Applications, R. Baker 2004).

FIG. 2. Is a bar graph showing the influence of contact time and particle size on antibacterial ability of ZnO.

FIG. 3. Is a micrograph showing the antimicrobial activity of ZnO applied to surfaces. A: ZnO electrodeposited on aluminum plates as a function of ZnO deposition time. Inhibition zones are denoted by the circle. B: ZnO-PMMA casting-composite film showing an inhibition zone.

FIG. 4. Are SEM micrographs of ZnO-PMMA embedded-composites at the end of the flow-through runs in the presence of a P. putida S-12 suspension (10³ CFU/ml for 48 hours at Re˜600). Left panels: control (virgin PMMA, ×5(A) and ×10(C)). Right panels: PMMA-ZnO (×5(B) and ×10(D)).

FIG. 5. Is a view of the polyacrylamide composite with 3% ZnO-nanoparticles.

FIG. 6. Is a micrograph of living bacteria remaining on LB agar-medium in Petri dishes, following direct contact in liquid medium of a 10⁶ CFU/ml P. putida S-12 suspension with PAA gel-composites with (control) and without 3% ZnO-np. Left panels: controls (1 hour top (A), 2 hours bottom (C)); Right panels: ZnO-np (1 hour top (B), 2 hours bottom (D)).

FIG. 7. Are SEM micrographs showing the influence of composite PAA-ZnO-nanoparticles (np) on biofilm development in flow-through runs in the presence of a P. putida S-12 suspension (10⁸ CFU/ml) for 72 hours. SEM micrographs at the end of the runs. Left panels, A and C: control without ZnO-np (PAA); B and D: composite PAA with ZnO-np (PAA ZnO). Numbers indicate magnification times 1,000.

FIG. 8. Is a bar graph showing the influence of ZnO-np on permeability decline in dead-end filtration on a 200 KDa polysulfone membrane fed with a 10⁵ CFU/ml P. putida S-12 suspension.

FIG. 9. Are SEM micrographs showing the influence of composite PMMA-ZnO-np spacer on biofilm development on a 200 KDa polysulfone membrane fed with a 10⁸ CFU/ml P. putida S-12 suspension in cross-flow regime. These SEM micrographs (A: PMMA control×10K, B: PMMA ZnO×10K, C: PMMA control×50K, D: PMMA ZnO×50K) of the membranes surface were taken at the end of the runs (˜72 hours), after dismounting the cells.

FIG. 10. Are SEM micrographs of commercial PP spacer treated by sonochemical deposition. (A) Surface of the spacer ×150. (B) Surface of the spacer (SE detector) ×30K. (C) Surface of the spacer (BSE detector) ×30K; dark—pp, white—ZnO np.

FIG. 11. Is a graph showing the EDS analysis of the embedded ZnO material.

FIG. 12. Is a micrograph showing the inhibition zone of the treated polypropylene spacer.

FIG. 13. Is a graph showing the normalized flux (Fₚᵢ/Fₚ₀) of permeate through a 200 KD PS membrane. Treated spacer showed a slower decrease of flux compared to the untreated spacer.

FIG. 14. Are HRSEM micrographs (×5K) of a commercial polypropylene spacer after 48 hours of exposure to flow with 10⁵ CFU·mL⁻¹ P. putida S12. (a) Unmodified spacer (b) Modified spacer with silver nitrate and ammonium hydroxide.

FIG. 15. Are HRSEM micrographs (×5K) of polysulfone membranes (200 KD) adjacent to spacers after 48 hours of exposure to flow with 10⁶ CFU·mL⁻¹ P. putida S12. (a) Unmodified spacer (b) Modified spacer with silver nitrate and ammonium hydroxide.

### DETAILED DESCRIPTION OF THE INVENTION

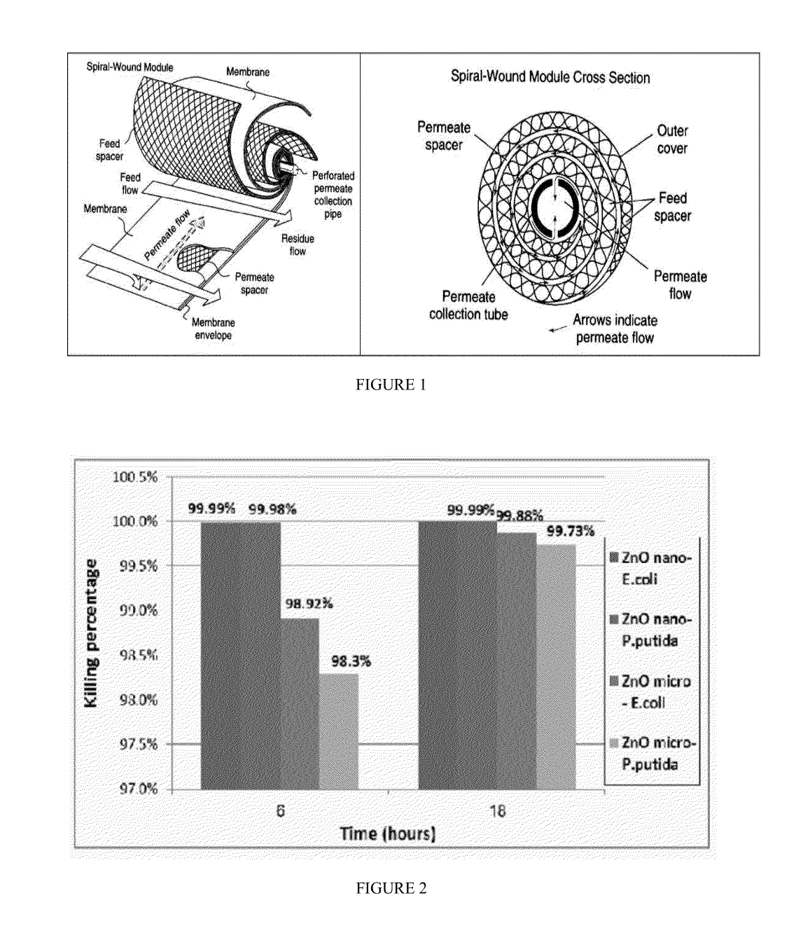

In one embodiment, the present invention provides a filtration module. In another embodiment, the filtration module comprises a tubular shape. In another embodiment, the filtration module is adapted for filtering a polar liquid. In another embodiment, the filtration module is adapted for filtering water. In another embodiment, a filtration module having tubular shape is a spiral wound filtration module having a high surface area and compact volume as shown in FIG. 1. In another embodiment, the filtration module comprises water.

In another embodiment, the filtration module is a biocidal filtration module. In another embodiment, biocidal is antibacterial. In another embodiment, a biocidal filtration module prevents the formation of biofilms on a surface of the filtration module. In another embodiment, a biocidal filtration module prevents colonization of bacteria on a surface of the filtration module.

In another embodiment, the present invention provides a filtration module comprising a membrane and at least one feed spacer, wherein the at least one feed spacer comprises (i) a polymeric matrix; and (ii) material having antimicrobial activity, wherein material is physically embedded into or attached to the polymeric matrix. In another embodiment, the present invention provides a filtration module having anti-biofouling properties to the at least one feed spacer. In another embodiment, attached is physically attached. In another embodiment, physically embedded is polymer-embedded. In another embodiment, physically embedded is fixed firmly and deeply in a surrounding polymer. In another embodiment, physically embedded or physically attached is ingrained.

In another embodiment, the present invention provides an antibacterial surface modification of spacers of a spiral wound filtration module. In another embodiment, the present invention provides an antibacterial surface modification of spacers of a spiral wound filtration module for preventing biofouling. This novel composite prevents biofouling in filtration systems. In another embodiment, all surfaces of the spacer are modified with a biocide as described herein. In another embodiment, the biocide is applied to the spacer by coating or by physical embedment.

In another embodiment, the invention further provides a method for preventing biofilm formation and reducing the need for addition of cleaning chemicals by utilizing the filtration module as described herein. By using materials with proven antibacterial properties embedded in the spacer surface, the initial formation of biofilm is prevented in the membrane-spacer contact area. In another embodiment, the invention further provides a generic tool for preventing biofouling in filtration systems without the need of modifying the active/selective layer of the membranes. In another embodiment, the filtration module reduces bacteria concentration in water passing therethrough.

In another embodiment, the filtration module is utilized in spiral wound RO and NF. In another embodiment, the filtration module is utilized in polymeric depth filters. In another embodiment, the filtration module is utilized in polymeric filter fabrics. In another embodiment, the filtration module is utilized in irrigation equipment. In another embodiment, the filtration module is utilized in polymeric pipes and conduits.

In another embodiment, the invention further provides a method and a process for making the filtration module as described herein. In another embodiment, metal oxides and/or Zn or Ag oxides nanoparticles were electrodeposited on gold coated-commercial polypropylene-PP spacer. In another embodiment, metal oxides and/or Zn or Ag oxides nanoparticles were prepared according to any method known to one of skill in the art. In another embodiment, metal oxides and or Zn or Ag oxides nanoparticles were further embedded and thus coated the spacer-polymer. In another embodiment, deposition of a nanoparticle comprising a biocide as described herein is performed by sonochemical deposition on polyprolpylene-PP. In another embodiment, deposition of a nanoparticle comprising a biocide as described herein is performed by casting on polymethyl methacrylate-PMMA (biocides such as: Ag₂O, ZnO). In another embodiment, deposition of a nanoparticle comprising a biocide as described herein is performed by entrapping in polyacrylamide-PAA. In another embodiment, these procedures resulted in a spacer composed of a polymeric matrix embedded with nanoparticles having antimicrobial activity.

In another embodiment, water is clean water. In another embodiment, water is bacteria polluted water or water comprising contaminants such as bacteria. In another embodiment, water is drinking water. In another embodiment, the filtration module is aimed at protecting the health of living organisms such as humans. In another embodiment, the filtration module is aimed at reducing the pollution of water in streams, lakes, rivers, wetlands and other waterways. In another embodiment, water is raw water. In another embodiment, water is rain water. In another embodiment, water comprises bacteria and viruses. In another embodiment, water comprises bacteria that adversely affect the thyroid gland, the liver or other vital body organs. In another embodiment, water comprises an atmospheric chemical. In another embodiment, water comprises dust. In another embodiment, water comprises smoke. In another embodiment, water comprises a mineral. In another embodiment, water comprises strontium 90. In another embodiment, water comprises lead. In another embodiment, water is soft water. In another embodiment, water comprises a trace mineral.

In another embodiment, water passing through the filtration module as described herein are contaminated with bacteria. In another embodiment, water to be passed through the filtration module as described herein do not meet the standards of the US environmental protection agency (EPA) with respect to the concentration of bacteria and/or the presence of harmful bacteria. In another embodiment, bacteria infected water passing through the filtration module as described herein become disinfected with harmful bacteria. In another embodiment, bacteria contaminated water which passed through the filtration module become suitable drinking water according to the EPA standards.

In another embodiment, the filtration module as described herein reduces the concentration of bacteria in water by at least 1.5 folds. In another embodiment, the filtration module as described herein reduces the concentration of bacteria in water by at least 2.0 folds. In another embodiment, the filtration module as described herein reduces the concentration of bacteria in water by at least 2.5 folds. In another embodiment, the filtration module as described herein reduces the concentration of bacteria in water by at least 3 folds. In another embodiment, the filtration module as described herein reduces the concentration of bacteria in water by at least 3.5 folds. In another embodiment, the filtration module as described herein reduces the concentration of bacteria in water by at least 4 folds. In another embodiment, the filtration module as described herein reduces the concentration of bacteria in water by at least 4.5 folds. In another embodiment, the filtration module as described herein reduces the concentration of bacteria in water by at least 5 folds. In another embodiment, the filtration module as described herein reduces the concentration of bacteria in water by at least 6 folds.

In another embodiment, the filtration module as described herein renders contaminated water-drinkable according to EPS standards and thus reduces the risk of illness from waterborne bacteria. In another embodiment, the filtration module as described herein is used to avoid bacterial slimes in irrigation wells that can clog pumps and pipes. In another embodiment, the filtration module as described herein is used as a sanitation practice.

In another embodiment, the filtration module comprises two membranes and a spacer sandwiched between the membranes. In another embodiment, the two membranes and the spacer are in direct contact. In another embodiment, the filtration module comprises a tubular shape wherein the tubular shape is composed of two permeable or a semi-permeable membrane layers (or membranes) and a spacer layer sandwiched between the two membrane layers, wherein the outer circumference of the module consists a membrane layer, and wherein the spacer layer is physically embedded with a biocide. In another embodiment, the filtration module is adapted for filtering water.

In another embodiment, a membrane is a membrane composed of a thermoplastic polymer. In another embodiment, a membrane is a membrane comprising a pore size of 0.1 μm-1 mm. In another embodiment, a membrane is a membrane comprising a pore size of 0.1 μm-500 μm. In another embodiment, a membrane is a membrane comprising a pore size of 2 μm-300 μm. In another embodiment, a membrane is a membrane comprising a pore size of 5 μm-250 μm. In another embodiment, a membrane is a membrane comprising a pore size of 10 μm-200 μm. In another embodiment, a membrane is a polysulfone membrane. In another embodiment, a membrane is a 200 KD filtration membrane.

In another embodiment, the filtration module comprises a single membrane and a spacer contacting the single membrane. In another embodiment, the filtration module comprises a tubular shape composed of a coiled (or spiraled) bilayer. In another embodiment, the bilayer comprises a permeable or a semi-permeable membrane layer directly contacting a spacer layer. In another embodiment, the outer circumference of the filtration module consists a membrane layer and not a spacer layer. In another embodiment, the spacer layer is physically embedded with a biocide. In another embodiment, the membrane layer is free of a biocide. In another embodiment, the membrane layer is free of a metal oxide.

In another embodiment, the filtration module is adapted to filter contaminants such as heavy metals. In another embodiment, the membrane layers within the filtration module are adapted to filter contaminants such as heavy metals. In another embodiment, the spacer layer within the filtration module is adapted to reduce the concentration of live bacteria within water that are in contact with the filtration module. In another embodiment, the spacer layer within the filtration module is further adapted to sandwich the membrane layers.

In another embodiment, the membrane layers or membranes within the filtration module are two membranes. In another embodiment, the two membranes are permeable. In another embodiment, the two membranes are semi-permeable. In another embodiment, one membrane is permeable and the second membrane is semi-permeable.

In another embodiment, a spacer layer is placed and/or sandwiched between the two membrane layers. In another embodiment, the spacer layer comprises polypropylene. In another embodiment, a membrane forms the outer circumference of the module as described herein. In another embodiment, the outer circumference of the module as described herein comprises a membrane. In another embodiment, the spacer layer comprises a biocide. In another embodiment, a spacer layer comprising a biocide is a spacer layer wherein the biocide is physically embedded onto the spacer's surface. In another embodiment, a biocide as described herein is attached to or bound to a nanoparticle or a microparticle which is embedded onto the spacer's surface. In another embodiment, a biocide is a metal oxide.

In another embodiment, the nanoparticle is an inorganic antibacterial nanoparticle. In another embodiment, the nanoparticle is a novel engineered nanomaterial. In another embodiment, the nanoparticle is a carbon nanotube. In another embodiment, the nanoparticle is a metal-oxide nanoparticle. In another embodiment, the nanoparticle is a ZnO nanoparticle.

In another embodiment, the nanoparticle is embedded within the spacer by sonochemical deposition. In another embodiment, the nanoparticle is embedded within the spacer by molecular layer deposition. In another embodiment, the nanoparticle is embedded within the spacer by ion sputtering. In another embodiment, the nanoparticle is embedded within the spacer by electrodeposition.

In another embodiment, the present invention provides for the first time a spacer having a biocide sandwiched between two membranes. In another embodiment, the present invention provides that the membranes are biocides free. In another embodiment, the present invention provides that the membranes are iron-oxide free. In another embodiment, biocide free is iron-oxide free. In another embodiment, the present invention provides that the spacer and not the membranes comprises a biocide. In another embodiment, the present invention is superior to the state of the art utilizing biocide modified membranes that hinder the membranal properties of membranes. In another embodiment, the present invention is superior to the state of the art utilizing biocide modified membranes that change the permeability and/or selectivity of the membranes.

In another embodiment, the present invention provides that a filtration module as described herein having a spacer comprising a biocide and one or two membranes that are biocide free has unexpected desired benefits over other filtration modules, these benefits include: durability, reduced biocide leakage, increased biocide properties, biofilm resistance, bacteria colonization resistance, and better output. In another embodiment, the present invention provides that a filtration module as described herein having a spacer comprising a biocide sandwiched between two membranes that are biocide free lasts longer compared to other filtration modules wherein the membrane is modified with a biocide. In another embodiment, the present invention provides that a filtration module as described herein having a spacer comprising a biocide sandwiched between two membranes that are biocide free has better flow parameters compared to other filtration modules wherein the membrane is modified with a biocide. In another embodiment, the present invention provides that a filtration module as described herein having a spacer comprising a biocide sandwiched between two membranes that are biocide free has better flow biocide properties compared to other filtration modules wherein the membrane is modified with a biocide. In another embodiment, other filtration modules are composed of the same membranes, biocide, spacer, particles (nano or micro) as the invention module wherein the biocide or biocide-particle is embedded in at least one membrane. In another embodiment, other filtration modules are composed of the same membranes, biocide, spacer, particles (nano or micro) as the invention's module wherein the biocide or biocide-particle is embedded in at least one membrane and not in a spacer.

In another embodiment, a biocide comprises a metal-oxide. In another embodiment, a biocide is ZnO. In another embodiment, a biocide is silver oxide. In another embodiment, a biocide is alumina (Al₂O₃). In another embodiment, a biocide is boron oxide (B₂O₃). In another embodiment, a biocide is a potassium oxide (K₂O). In another embodiment, a biocide is sodium oxide (Na₂O). In another embodiment, a biocide is iron oxide (Fe₂O₃). In another embodiment, a biocide is magnesium oxide (MgO). In another embodiment, a biocide is chlorine (Cl₂), hypochlorite ion and/or hypochlorous acid. In another embodiment, a biocide is chlorine dioxide (ClO₂). In another embodiment, a biocide is bromine (Br₂) or 1-bromo-3-chloro-5,5-dimthylhydantoin. In another embodiment, a biocide is copper oxide. In another embodiment, a biocide is nAg. In another embodiment, a biocide is TiO₂. In another embodiment, a biocide is silver nitrate. In another embodiment, a biocide is ammonium hydroxide.

In another embodiment, a spacer comprises at least 1% w/w biocide. In another embodiment, a spacer comprises at least 5% w/w metal-oxide. In another embodiment, a spacer comprises at least 1-30% w/w metal-oxide. In another embodiment, a spacer comprises at least 2-20% w/w metal-oxide. In another embodiment, a spacer comprises at least 5-15% w/w metal-oxide. In another embodiment, a spacer comprises at least 8-12% w/w metal-oxide. In another embodiment, a spacer as described herein comprises metal-oxide mainly on its upper layer surface. In another embodiment, a spacer as described herein comprises 0.5-20% w/w copper. In another embodiment, a spacer as described herein comprises 0.5-10% w/w copper. In another embodiment, a spacer as described herein comprises 1-5% w/w copper. In another embodiment, a spacer as described herein comprises 2.5-4.5 w/w copper.

In another embodiment, the present invention provides that the filtration module decreases the concentration of bacteria in water passing therethrough by at least half an order of magnitude. In another embodiment, the present invention provides that the filtration module decreases the concentration of bacteria in water passing therethrough by about (±15%) one order of magnitude.

In another embodiment, the present invention provides that the filtration module is a spiral wound module with novel bacterial sheet adhesion properties. In another embodiment, the present invention provides that the spacer is 100-5000 μm thick. In another embodiment, the present invention provides that the spacer is 200-2000 μm thick. In another embodiment, the present invention provides that the spacer is 400-1000 μm thick. In another embodiment, the present invention provides that the spacer is 600-800 μm thick.

In another embodiment, the present invention provides that a membrane is 20-4000 μm thick. In another embodiment, the present invention provides that a membrane is 500-2000 μm thick. In another embodiment, the present invention provides that a membrane is 100-1000 am thick. In another embodiment, the present invention provides that a membrane is 100-500 μm thick. In another embodiment, the present invention provides that a membrane is 200-400 μm thick.

In another embodiment, the present invention provides that the spacer is adapted to induce turbulent flow regime even in very low velocities. In another embodiment, the present invention provides that the spacer is adapted to induce a quasi-turbulent flow. In another embodiment, the present invention provides that the spacer is adapted to decrease the concentration polarization phenomena. In another embodiment, the present invention provides that the spacer is adapted to increase the surface area of fluid stagnation and propensity to biofouling.

Unless otherwise stated, the following terms used in this application, including the specification and claims, have the definitions given below. It must be noted that, as used in the specification and the appended claims, the singular forms “a,” “an” and “the” include plural referents unless the context clearly dictates otherwise. In this application, the use of “or” or “and” means “and/or” unless stated otherwise. Furthermore, use of the term “including” as well as other forms, such as “have”, “having”, “include”, “includes,” and “included,” is not limiting. The section headings used herein are for organizational purposes only and are not to be construed as limiting the subject matter described. In another embodiment, the term “comprising” is “consisting”.

Additional objects, advantages, and novel features of the present invention will become apparent to one ordinarily skilled in the art upon examination of the following examples, which are not intended to be limiting. Additionally, each of the various embodiments and aspects of the present invention as delineated hereinabove and as claimed in the claims section below finds experimental support in the following examples.

### EXAMPLES

Generally, the nomenclature used herein and the laboratory procedures utilized in the present invention include chemical, molecular, and microbiology techniques. Such techniques are thoroughly explained in the literature such as: “Series: Advances in Polymer Science”, Vol. 224 Meier, Wolfgang Peter; Knoll, Wolfgang (Eds.) 2010.

### Example 1

### Biocidal Membranes

Composite nanoparticles and microparticles having Zn and Ag oxides are described.

Escherichia coli CN13 and Pseudomonas putida S-12 were used as model bacteria. The materials were tested under static or flowing conditions as indicated.

First, the antimicrobial (killing) activity of micro and nano ZnO particles in slurry was evaluated on the model microorganisms as function of the contact time (FIG. 2). It can be seen that the nanoparticles show superior antimicrobial activity compared to the microparticles.

Next nanoparticles having antimicrobial activity were embedded and coated on polymers by several methods, including electrodeposition on a gold coated-commercial polypropylene-PP spacer (ZnO), sonochemical deposition on polyprolpylene-PP (ZnO), Casting on polymethyl methacrylate-PMMA (Ag₂O, ZnO), and entrapment in polyacrylamide-PAA(Ag₂O, ZnO). Following the above mentioned method, a polymeric matrix embedded with nanoparticles having antimicrobial activity was formed.

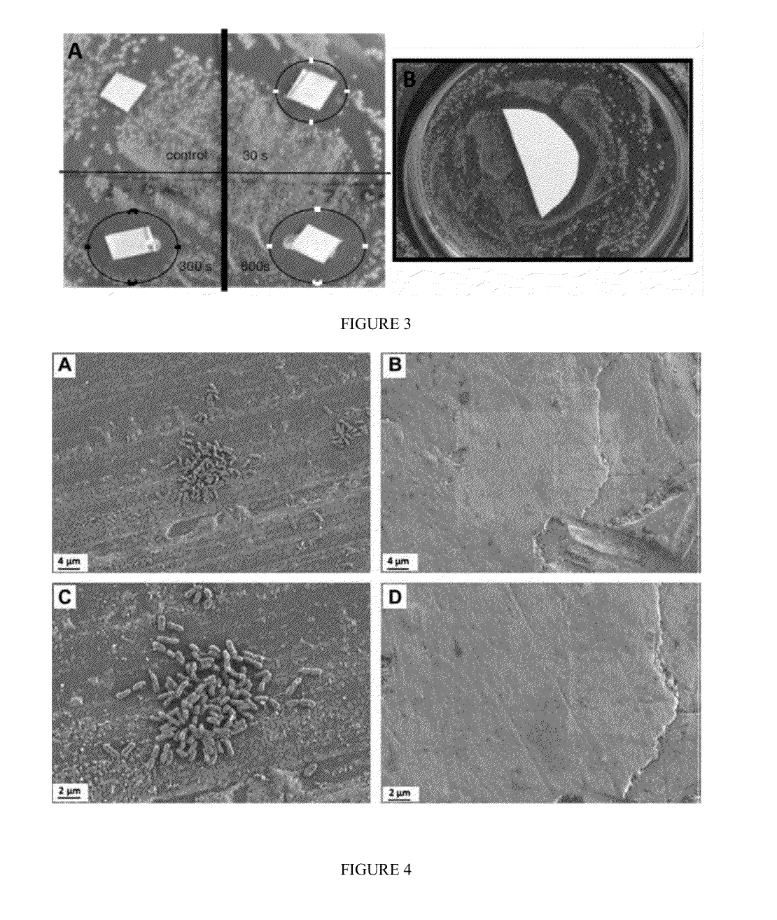

The antibacterial activity of these PMMA samples containing ZnO particles embedded in the polymer matrix (casting) and ZnO electrodeposited on aluminum plates (surface coating) were tested on the model bacteria by the inhibition zone method in static conditions (10⁶ CFU/ml E. Coli CN13 and P. putida S-12 were inoculated into LB agar-plates). In both cases a clear inhibition zone was observed, whose radius increased as a function of ZnO concentration (FIG. 3).

The ability of the composite material to prevent or decrease biofilm formation was further tested under flow-through regime in a laboratory setup under controlled and defined conditions, employing P. putida S-12 as model bacterium. This bacterium has proven capabilities for biofilm formation in flowing systems. The experiments were performed in the range of inoculated bacteria of 10³-10⁸ CFU/ml and laminar flow (Re=40-600).

The ability of ZnO-PMMA casting-composite film to prevent biofilm and adhesion at an initial bacteria concentration of 10³ CFU/ml and Re˜600 is depicted in FIG. 4 (A. Ronen et al. DWT 2012). Flow rate were kept in a laminar regime to simulate the flow in the filtration systems.

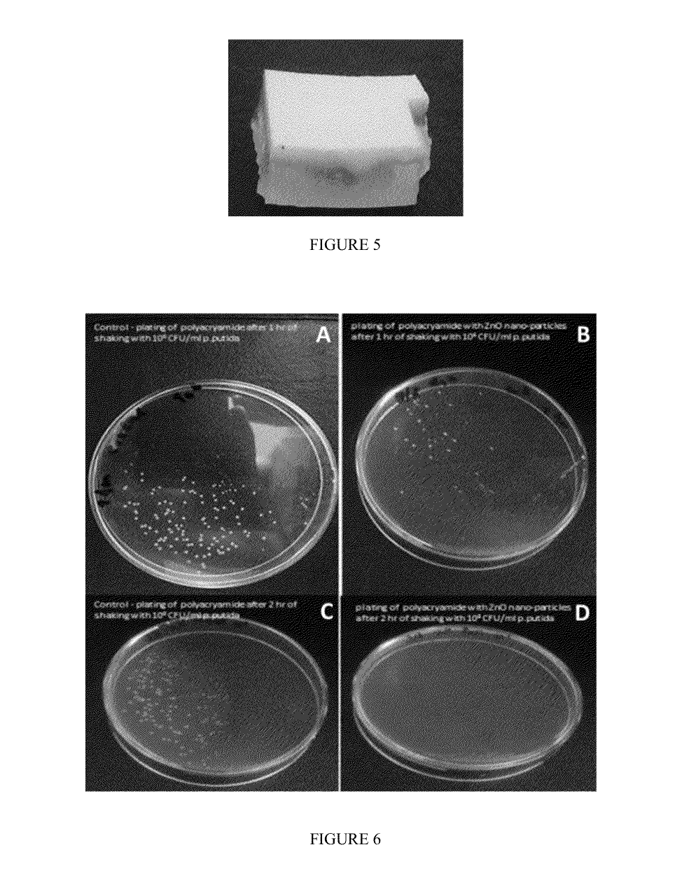

In order to prove the antibiofouling effect of the composite materials, a polyacrylamide (PAA) gel containing 3% (w/w) ZnO-np on its surface, mimicking an anisotropic composite-porous medium, was synthesized (FIG. 5, A. Ronen et al. DWT 2012). First, the antimicrobial activity of the PAA composite was tested in static liquid cultures for 1 and 2 hours while incubating with 10⁶ CFU/ml of P. putida S-12 (FIG. 6). Following this incubation, samples of the liquid were plated on LB medium for living cell counts. Results indicate that after 2 hours of contact there were no living bacteria left. One hour of contact reduced the population by more than 95%.

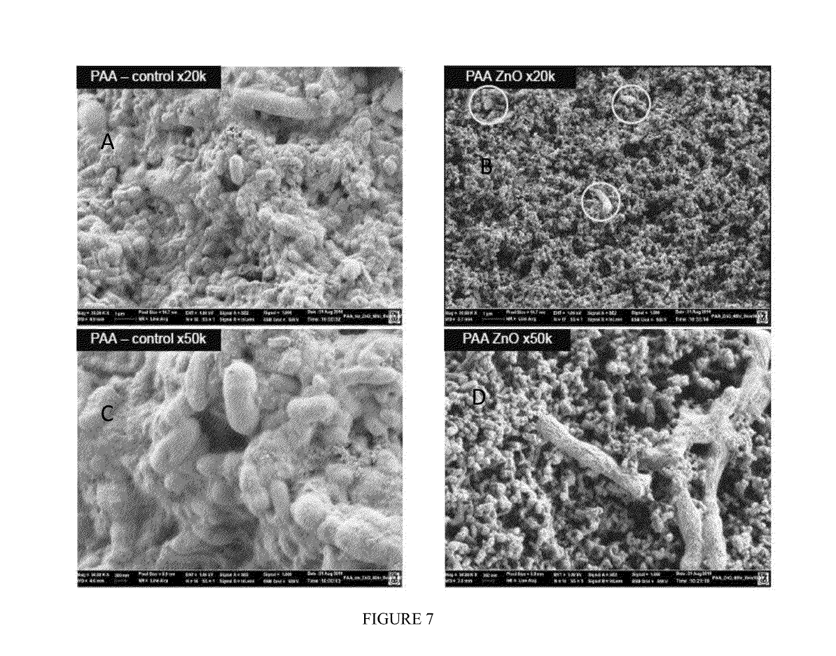

A full run in flowing conditions of the PAA-ZnO-np composites films with a high concentration of P. putida S-12 (10⁸ CFU/ml) for 72 hours is presented in FIG. 7 (A. Ronen et al. DWT 2012). Results indicated that only few bacteria remained attached to the PAA-ZnO surface compared to the developed biofilm found in the PAA—control after 72 hours. The fact that the remaining attached bacteria do not developed into a biofilm suggests that these are dead cells.

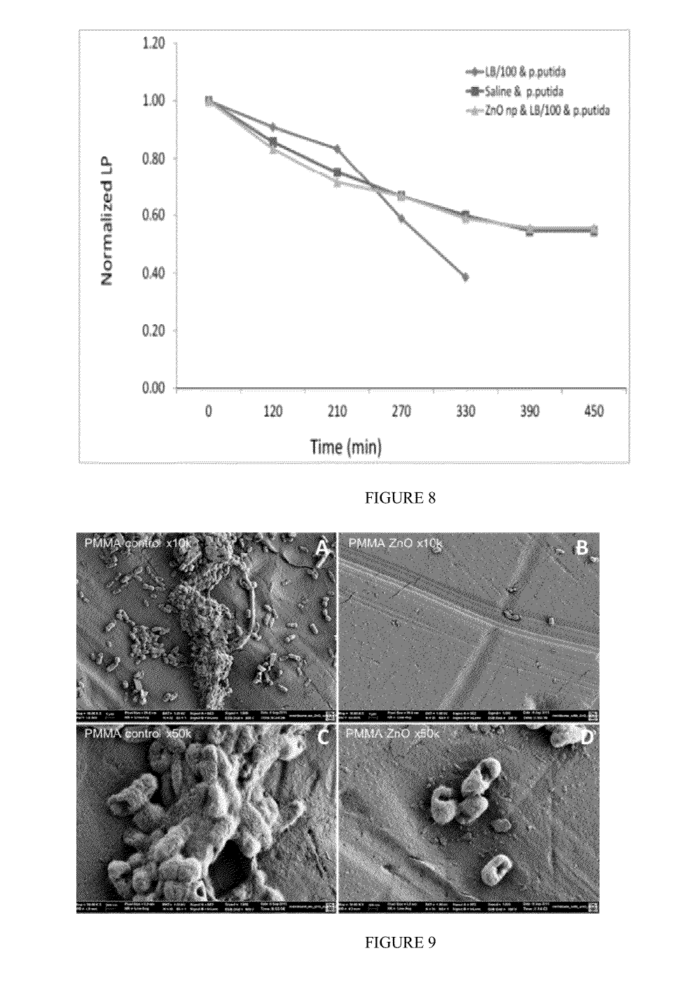

The influence of ZnO-np on membrane biofouling was tested, both in dead end and cross-flow regime. FIG. 8 shows the permeability decline with time on a 200 KD Polysulfone membrane fed with a 10⁵ CFU/ml P. putida S-12 suspension. As seen in FIG. 11, no effect on permeability was observed when ZnO-np were embedded in the membrane fed with bacteria suspended in diluted LB medium compared to the reference run with bacteria suspended in saline under sterile conditions. The decrease observed is due to colloidal deposition of single suspended bacteria. In contrast, in the control run (diluted LB media, absence of ZnO-np) a steep decrease in the permeability was faced and the membranes become completely clogged after 330 min. Due to the high pressure buildup inside the filtration cell (higher that the pump pressure) filtration was stopped and the run stopped.

The antibiofouling effect of a custom spacer (feed side) made from casting PMMA-ZnO-np, was tested in cross-flow regime on a 200 KDa polysulfone membrane, mimicking a real membrane module configuration, is presented in FIG. 9 (A. Ronen et al. DWT 2012). The runs were performed in laminar regime (Re˜600) with 10⁸ CFU/ml of P. putida for 72 hours. A PMMA custom made spacer without ZnO-np served as control.

At the end of the runs, the spacer was removed and the membranes were tested by SEM. It can be seen that the composite PMMA-ZnO np spacer significantly decreased the amount of bacteria attached to the membrane. These results indicate that only few bacteria remained attached to the membrane surface compared to the biofilm developed found in control after 72 hours. The fact that the remaining attached bacteria do not developed into a biofilm suggest that they are dead cells. In contrast the control shows typical biofilm colonies.

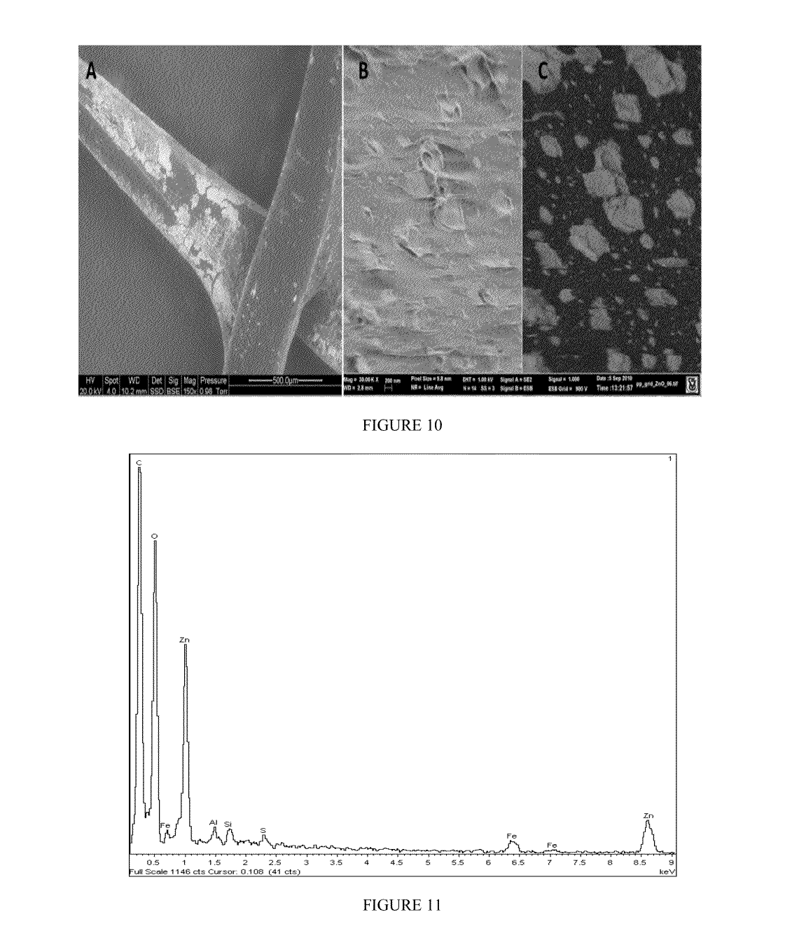

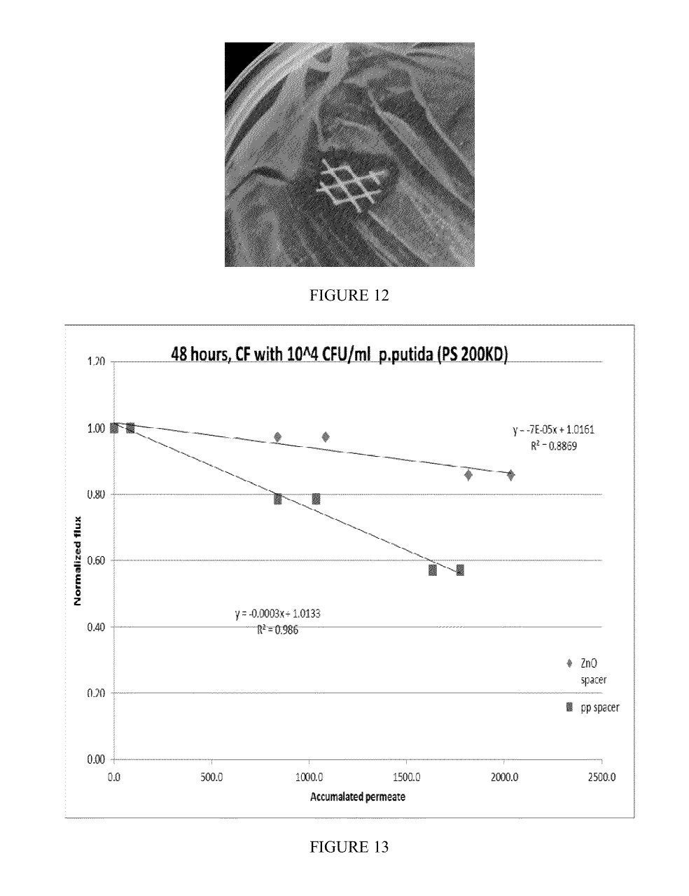

A commercial spacer was coated with ZnO using sonochemical deposition (3 hr in Zinc acetate dehydrate 0.05 M solution). Analysis of ZnO dispersion in the coated spacers revealed significant amounts of ZnO on surface, evenly distributed (FIG. 10). FIG. 11 further provides the EDS analysis of the embedded ZnO material. Specifically, this HRSEM-EDS analysis of the modified spacer was performed to confirm the coating composition. The EDS spectrum showed predominance of zinc and oxygen confirming that the coating material on the surface of the spacer is indeed ZnO, rating approx. 10% w/w. It should be noted that the coating is mainly on the upper layer of the sample meaning a high active concentration on the surface. The treated spacer was tested for antibacterial ability by Zone of inhibition and showed clear antibacterial ability (FIG. 12).

The Current modified spacer (MoSp) was further tested for antibacterial abilities in static and in flow conditions. In the direct contact of a bacterial suspension in static conditions experiments, one milliliter of a 10⁸-10⁶ CFU·mL⁻¹ suspension of P. putida S-12 or E. coli CN₁₃ in saline, was seeded on the specimen for the time duration indicated below. Following the contact period, samples of the liquid were plated on LB medium for living cell counts. The results are shown in table 1.

TABLE 1

Survival fraction (%)

| Sample | 3 hours | 15 hours |
|---|---|---|
| P. putida S12* | | |
| Initial saline | 89 | 71 |
| UmSp (unmodified spacer) | 94 | 53 |
| MoSp (modified spacer) | 0.001 | 0 |
| E. coli CN₁₃** | | |
| Initial saline | 80 | 64 |
| UmSp | 78 | 44 |
| MoSp | 0.001 | 0 |

The recorded antibacterial ability in static conditions was also tested using silver as the antibacterial agent. At the same tested parameters all bacteria were eliminated after less than 3 hours.

The antibiofouling effect of treated commercial spacer (feed side) was tested in cross-flow regime on a 200 KDa polysulfone membrane. The runs were performed in laminar regime (Re˜300) with 10⁴ CFU/ml of P. putida for 72-48 hour. An untreated polypropylene spacer served as control. During the runs, permeate flux was tested. It can be seen that the treated spacer shows a slower decrease in permeate flux compared to the untreated spacer (FIG. 13). The normalized flux of the treated spacer was 52% higher than the untreated one after 48 hours of run.

Leaching of Zinc from the spacer was tested. Treated spacer samples were immersed in DI (Deionized water) for 14 days. Samples were tested after 7 and 14 days by ICP for Zinc presence. The results showed negligible leaching (0.013% and 0.019%, respectively). A further experiment wherein the leaching of Zn was tested in DI and synthetic sea water (SSW) for 7 and 14 days at room temperature (25° C.), was performed. Samples sized 1 cm×1 cm were cut from the spacer and immersed in 50 mL of the tested solutions. The samples were shaken at 150 rpm during the length of the tests. At the indicated times, the solutions were sampled and the content of zinc was determined by ICP. The below tables 2 and 3 summarize the encouraging results:

TABLE 2

| | Initial Zinc | Leaching after | | Leaching after | |
|---|---|---|---|---|---|
| | concentration | 7 days | | 14 days | |
| Water | C₀ | C₇ | Leaching | C₁₄ | Leaching |
| Matrix | (mg/l) | (mg/l) | (%) | (mg/l) | (%) |
| DDW | 10000 | 0.7015 | 0.0007 | 1.05 | 0.001052 |
| Synthetic | 10000 | 0.8525 | 0.00085 | 1.15 | 0.00115 |
| sea water | | | | | |

Same parameters were tested for silver leaching but with more solutions: DI, synthetic sea water, and water at pH values of 3 and 12.

TABLE 3

| Water | Leaching after | Leaching after |
|---|---|---|
| matrix | 7 days (mg/l) | 14 days (mg/l) |
| DDW | ~0.1 | ~0.1 |
| Synthetic | 0.18 | 0.15 |
| sea water | | |
| pH 3 | 0.025 | 0.04 |
| pH 12 | 0.22 | 0.25 |

These results illustrate the antibiofouling activity of the different composites tested under different flow conditions, either by direct application or as a spacer for preventing biofouling development on an adjacent membrane. Thus the invention has tremendous advantage over the state of the art.

Further experiments that were conducted with intact modules comprising membranes revealed that the modified spacer completely inhibits colonialization of bacteria on the adjacent polysulfone membrane.

Moreover, the current results are superior compared to the state of the art such as United States patent application US2011/0120936 which shows data collected over 168 hours of contact. After 24 hours, attachment was 2.9×10⁶±2.9×10⁵ cells/cm² on the PP graft-GMA-IDA modified sheet versus 4.0×10⁷±2.1×10⁶ cells/cm2 on the virgin PP sheet.

Similar results were obtained at 96 hours, 3.1×10⁷±2.2×10⁵ cells/cm² on the PP-graft-GMA-IDA modified sheets; and 9.1×10⁸±3.9×10⁶ on the virgin PP sheets. The results at 168 hours were 4.5×10⁷±4.9×10⁴ on the PP-graft-GMA-IDA modified sheets; and 3.7×10⁸±1.1×10⁵ on the virgin PP sheets.

The number of cells attached to the PP-graft-GMA-IDA modified sheets was approximately an order of magnitude lower than those attached to the virgin PP sheets. While the PP-graft-GMA-IDA modified sheets were able to decrease the bacteria concentration by an order of magnitude compared to the virgin PP sheets (after 24 h), the current biocide modified spacer (MoSp) technology unexpectedly revealed complete elimination of bacteria at the same initial concentrations in less time, indicating a 6-7 orders of magnitude reduction compared to the state of the art.

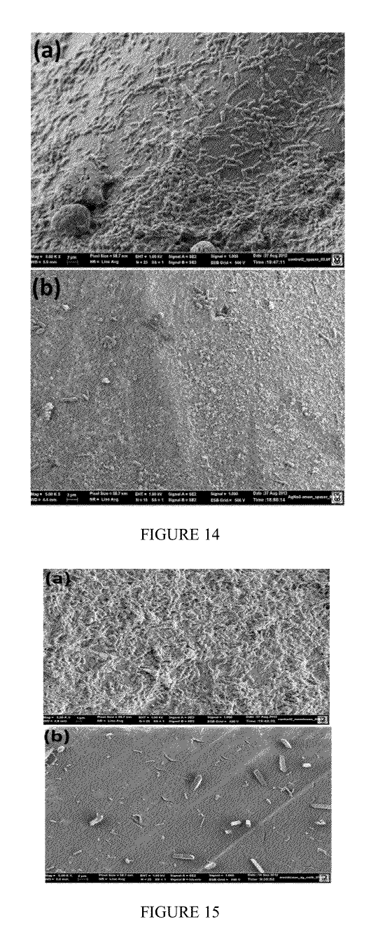

Similar experiments were performed with a silver embedded spacer. FIG. 14 further shows that a silver modified spacer inhibits the formation of biofilms whereas unmodified spacer served as excellent bedding for bacteria. A further experiment with an intact module revealed that the spacer inhibits the colonization of bacteria on the adjacent polysulfone membrane (FIG. 15). Parallel results were obtained with modules having copper modifies spacers.

In conclusion, the modified spacer (such as spacers embedded with ZnO or silver) showed strong, antibacterial abilities in static and flow conditions with less leaching of antibacterial agents.

This phenomenon was also apparent when the filtration module was assembled. Specifically, the membranes contacting a spacer were also resistant to bacterial attachment and growth thus rendering the filtration module extremely bacterial resistant and far more effective than other modules described in the prior art. Moreover, permeate flux decrease of the filtration module was hindered and leaching was minimized, when compared to biocide modified membranes.

What is claimed is:

1. A filtration module comprising at least one membrane layer and a spacer layer, wherein said spacer comprises (i) a polymeric matrix; and (ii) biocide, wherein said biocide is physically embedded into or attached to said polymeric matrix.

2. The filtration module of claim 1, having a tubular shape.

3. The filtration module of claim 1, wherein said spacer comprises anti-biofouling properties.

4. The filtration module of claim 1, wherein the outer circumference of said module consists a membrane layer.

5. The filtration module of claim 1, wherein said filtration module is adapted for filtering water.

6. The filtration module of claim 1, wherein said spacer layer comprises polypropylene.

7. The filtration module of claim 1, wherein said biocide is a metal oxide.

8. The filtration module of claim 1, wherein said biocide is ZnO.

9. The filtration module of claim 1, wherein said biocide physically embedded into or attached to said polymeric matrix is a biocide embedded into or attached to said polymeric matrix via a microparticle a nanoparticle.

10. The filtration module of claim 1, having a tubular shape, and comprises two permeable or a semi-permeable membrane layers and said spacer layer is sandwiched between said two membrane layers, wherein the outer circumference of said module consists a membrane layer.

11. The filtration module of claim 1, having a tubular shape, and comprises a coiled bilayer, said bilayer comprises a single permeable or semi-permeable membrane layer directly contacting a single spacer layer, wherein the outer circumference of said module consists said membrane layer.

12. A method for reducing the concentration of bacteria in water, comprising the step of contacting said water with the filtration module of claim 1.

13. The method of claim 12, wherein said spacer layer comprises polypropylene.

14. The method of claim 12, wherein said biocide is a metal oxide.

15. The method of claim 12, wherein said biocide is ZnO.

16. The method of claim 12, wherein said biocide physically embedded into or attached to said polymeric matrix is a biocide embedded into or attached to said polymeric matrix via a microparticle a nanoparticle.

17. The method of claim 12, wherein said filtration module comprises a tubular shape and two permeable or a semi-permeable membrane layers and said spacer layer is sandwiched between said two membrane layers, wherein the outer circumference of said module consists a membrane layer.

18. The method of claim 12, wherein said filtration module comprises a tubular shape and a coiled bilayer, said bilayer comprises a single permeable or semi-permeable membrane layer directly contacting a single spacer layer, wherein the outer circumference of said module consists said membrane layer.
